(19) United States
(12) Patent Application Publication
(10) Pub. No.: US 2006/0099096 A1
(43) Pub. Date: May 11, 2006

(54) Scroll pump system

(76) Inventors: Robert W. Shaffer, Hamilton, OH (US); Glenn Paul Wagner, Fogelsville, PA (US); Roger Dean Whitley, Allentown, PA (US); Matthew James LaBuda, Fogelsville, PA (US); James Michael Occhialini, New Tripoli, PA (US); William Curtis Kottke, Fogelsville, PA (US)

Correspondence Address: JONES DAY, 222 EAST 41ST ST, NEW YORK, NY, 10017, US

(21) Appl. No.: 10/984,607

(22) Filed: Nov. 8, 2004

(51) Int. Cl. F01C 1/02; F04C 2/00; F01C 1/063; F03C 2/00; F04C 18/00; F03C 4/00

(52) U.S. Cl. 418/55.1; 418/55.2

(57) ABSTRACT

The present invention provides a scroll pump device comprising external and internal scroll members, and wherein the scroll pump device is separated into inner and outer zones. The flow streams in the two zones are kept separate, and each stream may have different chemical compositions and flow rates. The scroll pump system can provide both vacuum and pressure flow streams in a compact lightweight package, and may be used for the separation and concentration of oxygen from atmospheric air, for use, inter alia, in portable medical systems.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention is directed to a scroll pump system. More particularly, the present invention is directed to a scroll pump system which can provide both vacuum and pressure flow streams, or two pressure streams, or two vacuum streams in a single, portable apparatus, and may be used, inter alia, in an oxygen generator for medical use, where compact size and low weight are essential.

Several methods are known for the ambient temperature separation and concentration of fluids, such as oxygen and nitrogen from air. Suitable methods include, but and not limited to, membrane separation, pressure vacuum swing adsorption (PVSA) and processes using oxygen adsorbents such as molecular sieves.

Pressure vacuum swing adsorption is effected by the use of adsorbents and a pressure-vacuum process, operating between two different pressures. First, in a high pressure step, an adsorbent adsorbs one or more elements or compounds, e.g., contaminants, from a feed gas, leaving an enriched product to exit the product end of the adsorbent bed. As additional feed gas is passed through the apparatus, the removed one or more elements or compounds accumulate in the adsorbent. When the amount of adsorbed material reaches a certain level, the capacity of the adsorbent to adsorb additional material becomes diminished, and the adsorbent must be regenerated. The regeneration process takes place in another, low pressure step. In this step, the adsorbed components are released by the adsorbent, and extracted as a waste gas from the adsorbent beds typically at a sub-atmospheric pressure. This low pressure part of the process may also include a purge step, where a portion of the enriched product gas is used to drive the undesired molecules back towards the feed end of the bed. Such a purge step would also require the extraction of both the waste and purge gases from the beds.

One way to provide the needed gas flows and pressures is to use two machines: a feed gas compressor for the high pressure portion of the cycle, and a vacuum pump to provide the lower pressure for the low pressure portion. Combining the compressor and vacuum pump into a single device reduces the size and weight of the machinery. Of the varieties of pumps that may be used, a scroll pump has several advantages, including low vibration and low noise, making it ideally suited for use in a portable device.

Scroll pump devices are well known in the art, and may be used for both pressure and vacuum service. Typically, scroll pump devices comprise interfitting spiral elements which are disposed adjacent to each other on separate end plates. The spiral or scroll members make moving contact with each other, producing defined volumes of fluid which move according to the relative motion of the scroll members from a fluid inlet to a fluid outlet.

U.S. Pat. No. 6,709,248 discloses a scroll pump that can serve as both a compressor and a vacuum pump. The patent discloses a scroll pump which consists of an inner and an outer sealed chamber, the chambers separated by an annular partition. The arrangement of the two separate chambers separated by the annular partition is not a compact arrangement, which may be desirable or necessary for some applications, for example, portable oxygen concentrators.

U.S. Pat. No. 4,157,234 discloses a scroll pump which provides two stages of compression. The scroll pump is constructed so as to accommodate inter-stage cooling of the fluid, and therefore, it requires the interconnection of the fluid flow between the two stages.

U.S. Pat. No. 6,050,792 discloses the use of a multi-stage scroll compressor with a single continuous scroll as a compressor or a vacuum pump and wherein the height of the scroll for each stage may be different. An intermediate port between the stages can be used as an inlet or discharge. The streams in the two stages are mixed at the intermediate port.

U.S. Pat. No. 6,511,308 discloses the use of a sealant for the tips and sides of compressor scrolls to reduce the clearance between the mating parts, in order to improve the performance of the compressor. Such a technique is advantageous, especially for small, low flow scroll compressors, where leakage is particularly detrimental to performance. The contents of the above U.S. patents are incorporated herein by reference in their entirety.

Thus, while the use of devices such as scroll pumps for the separation and concentration of fluids such as gases is known, such scroll pump devices are unsuitable for use in small portable devices. There therefore remains a need for an effective portable device for the concentration and generation of gases. The present invention provides such an effective device that may be in the form of a highly compact portable scroll pump device for use, for example, for oxygen concentration and generation.

### SUMMARY OF THE INVENTION

The invention consists of a scroll pump device comprising: an external scroll member having a first spiral element comprising more than one wrap on a face of the external scroll member, the exterior end of which first spiral element meets the previous wrap of the first spiral element so as to define a volume, and wherein the external scroll member further comprises a bridging member between two wraps of the first spiral element that divides the volume defined by the first spiral element into an inner zone and an outer zone; the scroll pump further comprises an internal scroll member having a second spiral element comprising more than one wrap on a face of the internal scroll member facing the first spiral element on the external scroll member, and wherein the second spiral element is discontinuous at a position corresponding to the bridging member of the external scroll member; a motor that is capable of moving one of the scroll members in an orbital motion relative to the other scroll member; and wherein the inner and outer zones are not fluidly connected, each separate zone having a zone inlet and a zone outlet, and wherein independently in each zone fluid is introduced via a zone inlet and discharged via the corresponding zone outlet. Typically the motor is attached to one scroll member via a drive shaft which extends axially from the motor.

In another embodiment, the fluids introduced into the inner and outer zones of the scroll pump device may be the same or different, and may have different molar flow rates and different chemical compositions. In another embodiment, the scroll members have an epoxy sealant applied to their surfaces to provide improved sealing between the scroll members.

In one embodiment, one zone of the scroll pump device is used for vacuum pumping and the other zone is used for compression. In another embodiment the outer zone is used for vacuum pumping and the inner zone is used for compression. The outer zone can produce a vacuum of from between about 4 psia and about 8 psia, and more preferably about 6 psia, while the inner zone can produce a compression of a feed gas from atmospheric pressure to between about 20 psia and about 34 psia, and more preferably from atmospheric pressure to about 26 psia. In another embodiment the vacuum zone provides vacuum pressure and flow using fewer spiral wraps than necessary to compress the gas to atmospheric pressure.

In one embodiment, the external and internal scroll members are constructed from aluminum or magnesium. The external and internal scroll members may each individually weigh from about 0.05 kg to about 2 kg, and preferably may individually weigh from about 0.05 kg to 0.30 kg.

In one embodiment the internal scroll member is the orbiting member, and the external scroll member is the fixed member.

In another embodiment, the scroll pump device weighs from about 0.25 kg to about 3 kg, and preferably from about 0.25 kg to about 1.5 kg.

In another embodiment is provided a method of separating and concentrating a component of a fluid using the scroll pump device of the present invention, comprising the steps of: introducing the fluid into the compression zone of the scroll pump device to provide a pressurized fluid feed stream; introducing the pressurized fluid feed stream into a separator/concentrator, wherein the separator/concentrator is fluidly connected to the scroll pump device, and is adapted to separate the components of the pressurized fluid feed stream to produce a concentrated product fluid and a waste fluid; collecting the concentrated product fluid from the separator/concentrator; and removing the waste fluid from the separator/concentrator by operation of the vacuum zone of the scroll pump device. In a preferred embodiment the fluid is air and the concentrated fluid is oxygen.

In other embodiments both zones of the scroll pump device are used for vacuum pumping or for compression.

In another embodiment the separator/concentrator in fluid connection to the scroll pump device is a pressure vacuum swing adsorption system adapted to separate the pressurized feed air into oxygen-rich product fluid and oxygen-depleted waste fluid. The separator/concentrator generates oxygen at a flow rate suitable for use in portable medical systems, typically about 10 liters per minute or less.

In another embodiment the separator/concentrator in fluid connection to the scroll pump device generates oxygen at a rate of from about 0.5 to about 6 liters per minute, and more preferably at a rate of 0.5 to 3 liters per minute of oxygen, and wherein the oxygen is at least 85% pure.

In another embodiment, the scroll pump device of the invention is suitable for use in a portable medical oxygen generator.

### BRIEF DESCRIPTION OF THE DRAWINGS

The features and advantages of the present invention will become more apparent from the following description with respect to an embodiment as shown in appended drawings, wherein:

FIG. 1 is a vertical cross-sectional side view of an embodiment of a scroll pump device.

FIG. 2 is a section view of the scroll pump device of FIG. 1, taken at the location of section lines A-A.

FIG. 3 is an exploded view of the scroll pump device of FIG. 1.

### DETAILED DESCRIPTION OF THE PREFERRED EMBODIMENT

Typically, scroll pump devices comprise interfitting spiral elements which are disposed adjacent to each other on separate end plates. The spiral elements have identical pitches, so that crescent-shaped pockets of fluid are formed between the spiral elements. One of the spiral elements is constrained to orbit in a circular motion without rotating. As the spiral elements orbit relative to one another, the pockets move toward the center of the spiral and decrease in volume, compressing the fluid contained therein. An inlet port at the outer end of the spiral element provides an inlet for fluid to enter the pump, and a port at the innermost end of the spiral element provides an outlet for the fluid, which has been compressed to a higher pressure, to exit.

As will be discussed in greater detail below, the present invention provides a scroll pump device comprising an external scroll member having a spiral element comprising more than one wrap, the end of which spiral element is attached to the preceding wrap of the spiral element, so as to form an enclosed spiral shaped volume. This spiral shaped volume is interrupted by a bridging member, dividing the volume into two separate volumes. The spiral element of the external scroll member may be referred to as the first spiral element. The scroll pump device of the present invention further comprises an internal scroll member having a spiral element on one side face facing the external scroll, and wherein the spiral element is discontinuous at a position corresponding to the bridging member. The bridging member provides two separate zones, one inner zone and one outer zone, wherein the inner and outer zones are not fluidly connected, each separate zone having an inlet and an outlet, and wherein in either zone fluid introduced via the zone inlet may be compressed and discharged via the corresponding zone outlet. The spiral element on the internal scroll member may be referred to as the second spiral element. If desired, the first spiral element may have different thicknesses, in the radial direction, on either side of the bridging member, and the second spiral element may also have different thicknesses on either side of the discontinuity. A motor capable of moving one of the scroll members in an orbital motion relative to the other scroll member can be attached to either the internal or the external scroll member via a drive shaft. The scroll member attached to the drive shaft is driven in an eccentric orbit with respect to the drive shaft. The term “eccentric,” as defined herein, is understood to mean a translational motion in a circular orbit.

The two separate zones of the scroll pump device of the present invention allow for the fluids introduced into each zone to be the same or different. For example, the two fluids can differ in properties including, but not limited to, chemical compositions, molar flow rates and/or pressures. The fluids in each separate zone do not come into contact with each other, and therefore any potential contamination of the separate fluid streams is avoided.

The scroll pump device of the present invention operates in a manner similar to that of conventionally-known scroll pump devices, in that interfitting spiral elements which are disposed adjacent to each other on separate end plates make moving contact with each other, thus producing defined volumes of fluid which move according to the relative motion of the scroll members from a fluid inlet to a fluid outlet. If the movement of the fluid is from a volume of lower pressure to one of higher pressure, the device is acting as a compressor. The term “fluid,” as defined herein, is understood to mean a gas. A preferred fluid is air or its constituents.

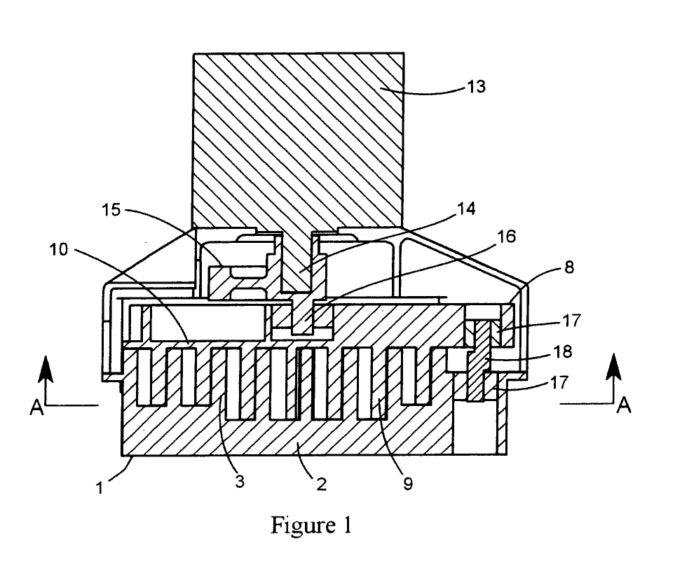

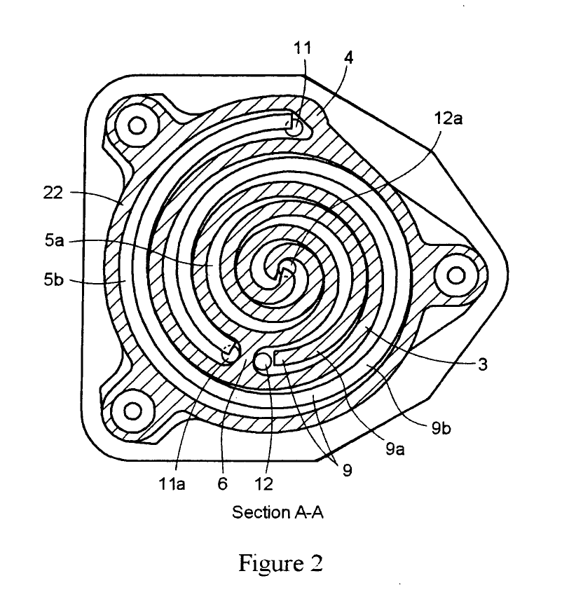

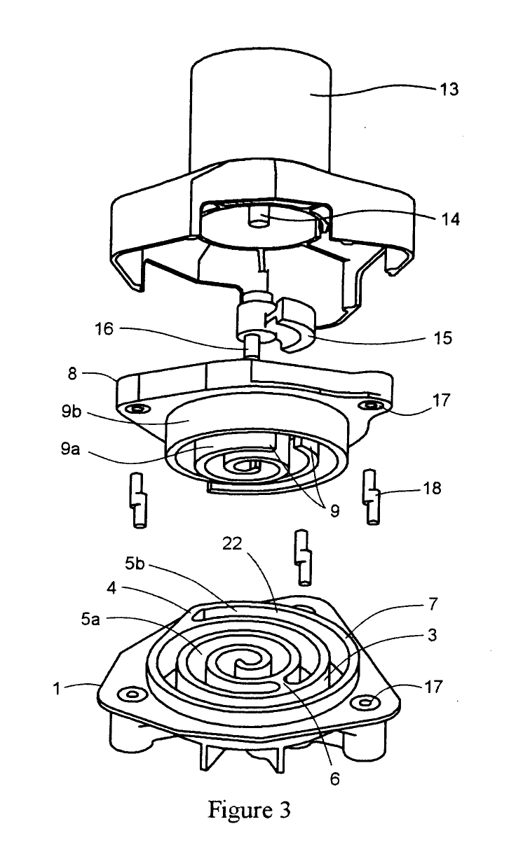

FIGS. 1 and 2 show cross sections of a first embodiment of the present invention. FIG. 3 shows an exploded view of one embodiment of the scroll pump device of the invention. The scroll pump comprises an external scroll member 1, which comprises a spiral element 3 extending from an end plate 2. The spiral form of the spiral element 3 is generally defined by an involute of a circle. The term “wrap” is used to refer to one revolution around the center of the spiral. The spiral elements comprise at least one wrap and may comprise additional wraps and/or portions of a wrap. The number of wraps in the spiral is determined by the desired compression ratios of the compressor and vacuum pump. The higher the desired compression ratio, the greater the required number of wraps. The exterior end of the spiral element 3 is attached to the next inward wrap of the spiral element 3 by a connection 4. The outermost wrap 22 and connection 4 define the outer pressure boundary of the pump. The volume thus enclosed is further divided into two zones or chambers 5a and 5b by bridging member 6, the location of which is determined by the desired pressure ratios of the compressor and vacuum pump. The zones created by the bridging member may be different depths from face 7 of external scroll 1.

Internal scroll member 8 comprises a spiral element 9 extending from endplate 10. The pitch and number of wraps of spiral element 9 is selected so as to interlock with spiral element 3 of external scroll member 1. Internal scroll member 8 is characterized in that the spiral element 9 is discontinuous, creating an inner internal spiral element 9a and an outer internal spiral element 9b. The location of the discontinuity in spiral element 9 corresponds to the location of bridging member 6 of external scroll member 1. Inner internal spiral element 9a and outer internal spiral element 9b may extend the same distance from end plate 10, or may extend different distances. The distance by which each spiral element 9a or 9b extents from face of end plate 10 is essentially equal to the depth of corresponding zone 5a or 5b in external scroll member 1. The heights of spiral elements 9a and 9b are selected so that the flow produced by each scroll zone matches the flow requirements of the apparatus or system that the scroll pump is designed for, for example, a PVSA process stream to which the scroll zone is connected. The flow for a given scroll zone will be approximately proportional to the height of the scroll. Thus, by adjusting the height of the scroll members of each zone, it is possible to produce different molar flow rates in each zone

The bridging member 6, along with the discontinuous nature of the spiral element 9, results in the formation of two separate zones within the scroll pump device. Each zone has an inlet and outlet. In the outer zone, feed gas enters the device at inlet 11. The fluid is compressed as it travels along the length of spiral element 9b, and compressed fluid exits the device at outlet 11a. In the inner zone, fluid enters at inlet 12, is compressed as it travels along the length of spiral element 9a, and exits at outlet 12a. The inlet and outlet ports can be located on the fixed scroll member, meaning the scroll member that is stationary.

Typically operation of the scroll pump takes place with very small clearance between the scroll members. However, leakage can occur at the tips and flanks of the scroll members. Such leakage can be reduced by the use of a viscous spreadable material at the tip seals and other points of possible leakage. Suitable viscous spreadable materials include grease, dampening gel and epoxy materials. The use of such sealants is described in U.S. Pat. No. 6,511,308, the contents of which are incorporated herein by reference in their entirety.

The inner and outer zones are not fluidly connected. As the two zones are not fluidly connected, the fluids may flow through the separate zones at identical or different molar flow rates, and they may have identical or completely different chemical compositions, and/or different pressures. Thus, in one embodiment, the scroll pump device of the present invention can function as both a compressor and a vacuum pump, with, for example, compression being effected by the inner zone while vacuum pumping is effected by the outer zone of the pump or compression being effected by the outer zone while vacuum pumping is effected by the inner zone of the pump. Alternatively, both zones may provide compression at the same or different pressures, or both zones may provide vacuum at the same or different pressures.

The compression ratio of a scroll compressor is determined by the number of wraps of a spiral elements. The number of wraps determines how much the size of the pockets, i.e., the volumes of trapped fluid within each zone, formed between the scroll members changes between the inlet and outlet ports, and is related to the pressure ratio. Normally, to compress a fluid from one pressure to another, the scroll would have a number of wraps that would achieve the desired pressure ratio. However, for a vacuum pump, where the discharge pressure is atmospheric, compression of outlet gas to atmospheric pressure is not necessary. All that is necessary is to have a scroll with the necessary displacement at the vacuum pump inlet to move the required volume of gas from the evacuated space, and to have more than one wrap, so that a complete fluid chamber may be formed between the fixed and orbiting scrolls, to prevent fluid from the discharge from flowing backwards to the inlet. Using this technique allows the vacuum pump to operate with fewer wraps than would normally be expected for a conventional compressor. This results in substantial reduction in size, which is especially advantageous for example for portable oxygen concentration devices.

Therefore, in a preferred embodiment of the present invention, the outer zone of the scroll pump functions as a vacuum pump, since it will not require much more than one wrap of the spiral element and the inner zone functions as a compressor, where the number of wraps required by the compression ratio will take up the smallest space. Without being bound by theory, it is believed that this configuration is advantageous for processes which require greater volumetric flows of vacuum than of pressure since the outer zone will comprise larger pockets of fluid than the inner zone for a given scroll height, due to the physical configuration of the scroll pump. In this way, a higher vacuum may be effected while keeping the height of the scroll pump at a minimum, and thus leading to a lighter scroll pump device.

Typically, the scroll pump device of the present invention can produce a vacuum within the range of about 4 psia to about 8 psia at the inlet of one zone, and produce a compression of feed gas from atmospheric pressure at the inlet to about 34 psia at the outlet of the second zone. In a preferred embodiment, the scroll pump device of the present invention can produce a vacuum of about 6 psia at the inlet of one zone, and produce a compression of feed gas from atmospheric pressure at the inlet to about 26 psia at the outlet of the second zone. In a preferred embodiment the outer zone functions as a vacuum pump and the inner zone functions as a compressor.

FIG. 3 shows an exploded view of one embodiment of the scroll pump device of the present invention. Scroll members 1 and 8 are constrained so that one of the members moves in a circular orbit relative to the other. The constraining of the scroll members is brought about by use of a number of bearings 17 and cranks 18 disposed between the two scroll members. One of the scroll members is a stationary member, while the other scroll member will orbit relative to the stationary member. The orbiting member is selected from either scroll member, and is attached to a motor 13 via a drive shaft 14. It makes no difference for the operation of the pump which member is fixed and which is stationary; the pump will work equally well either way. In a preferred embodiment of the scroll pump device, the internal scroll member is the orbiting member.

The motor 13 may be powered by any suitable method, and is typically powered by a battery. Projecting axially from the motor 13 is drive shaft 14. Attached to the drive shaft 14 is an eccentric/counterweight 15. Projecting from the end of the eccentric/counterweight 15 is a pin 16. Pin 16 is eccentric to the axis of drive shaft 14 by an amount equal to the radius of the orbit of the orbiting scroll member, and moves the orbiting scroll member as the motor shaft rotates.

Without being bound by theory, it is understood that as the orbiting scroll moves in its orbit, it creates a rotating unbalance force equal to meω², where:
m=mass of the scroll
e=eccentricity
ω=rotational velocity of the motor shaft or orbiting scroll.

The purpose of the counterweight is to create an equal and opposite unbalanced force, so that the compressor runs with minimal vibration. Since the counterweight has the same rotational speed as the orbiting scroll, it must also have an identical me product as the orbiting scroll, where m is the mass of the counterweight, and e is the radius of its centroid. To keep the mass of the counterweight to a minimum, it is therefore desirable to keep the mass of the orbiting scroll as small as possible. For this reason, the preferred embodiment of the invention has the internal, or male, scroll as the orbiting member, since for the embodiment shown, it is has the least weight of the two scrolls.

In one embodiment, to keep the total weight of the pump to a minimum, external scroll member 1 and internal scroll member 8 are constructed from a low density material, and are preferably constructed from an aluminum or magnesium alloy.

External scroll member 1 and internal scroll member 8 may each individually weigh from about 0.05 kg to about 1.5 kg. Preferably, each scroll member each individually weighs from 0.05 kg to 0.30 kg. In a most preferred embodiment, the internal scroll member 8 weighs less than external scroll member 1.

In a preferred embodiment of the invention, the scroll pump device, including motor 13, weighs from about 0.25 kg to about 3 kg. Most preferably, the scroll pump device, including motor 13, weighs from about 0.25 kg to about 1.5 kg.

In another embodiment, the present invention provides a method of separating and concentrating a component of a fluid using a scroll pump device. The method comprises the introduction of the fluid into the compression zone of the scroll pump device to provide a pressurized fluid feed stream, then passing the pressurized fluid feed stream into a separator/concentrator apparatus such as a pressure vacuum swing adsorption system to separate the components of the pressurized fluid feed stream. The separator/concentrator apparatus is in fluid communication with the compression zone of the scroll pump device. The separator/concentrator typically produces a concentrated product fluid in one step, and a waste fluid in a different step. The concentrated product fluid is collected from the separator/concentrator, and the waste fluid is purged from the separator/concentrator apparatus by operation of the vacuum zone of the scroll pump device, the separator/concentrator apparatus being in fluid communication with the vacuum zone of the scroll pump device. In a preferred embodiment, the compression zone of the scroll pump device is the inner zone and the vacuum zone is the outer zone.

In a preferred embodiment, the method of the present invention is used to separate and concentrate oxygen gas from air. In this embodiment, the scroll pump device of the present invention is used with a pressure-vacuum swing adsorption apparatus adapted to separate and concentrate a feed supply of pressurized air into an oxygen-rich product fluid and an oxygen-depleted waste fluid. The pressure vacuum swing adsorption apparatus typically comprises a number of adsorber beds containing adsorbent materials selected so as to adsorb water, carbon dioxide and nitrogen from air. The adsorber beds may be operated in turn through an adsorption cycle which includes the steps of supplying feed fluid, such as air, to the beds, depressurizing, evacuating waste materials from the beds and reforming the adsorber beds, and subsequently repressurizing the adsorber beds. The use of such pressure vacuum swing adsorption systems is described in co-pending U.S. application Ser. No. 10/851,858.

In one embodiment the scroll pump device provides feed air and vacuum pumping at rates and pressures suitable for use in a portable medical oxygen generator. The term “oxygen generator,” as defined herein, is understood to be a device which generates oxygen, and includes, but is not limited to, separators and concentrators. Typically, the separator/concentrator apparatus, when used in medical oxygen concentrator systems produces an oxygen flow rate of about 10 liters per minute or less. In a preferred embodiment, the scroll pump device of the present invention is used in a portable medical oxygen concentrator, wherein the separator/concentrator apparatus typically produces a flow rate of from 0.5 to 6 liters per minute of oxygen. In a most preferred embodiment, the scroll pump device of the present invention is used in a portable medical oxygen generator that produces a flow rate of from 0.5 to 3 liters per minute of oxygen, wherein the oxygen is at least 85% pure, and more preferably at least 90% pure.

The present invention is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims.

All references cited herein are hereby incorporated herein by reference in their entirety for all purposes.

We claim:

1. A scroll pump device comprising:
an external scroll member having a first spiral element comprising more than one wrap on a face of said external scroll member, the first spiral element has an exterior end, said exterior end of said first spiral element meets the previous wrap of said first spiral element so as to define a volume, and wherein said external scroll member further comprises a bridging member between two wraps of said first spiral element that divides said volume defined by said first spiral element into an inner zone and an outer zone; said scroll pump further comprises an internal scroll member having a second spiral element comprising more than one wrap on a face of said internal scroll member facing said first spiral element on said external scroll member, and wherein said second spiral element is discontinuous at a position corresponding to the bridging member of said external scroll member;
a motor that is capable of moving one of said scroll members in an orbital motion relative to the other scroll member; and
wherein the inner and outer zones are not fluidly connected, each separate zone having a zone inlet and a zone outlet, and wherein independently in each zone fluid is introduced via a zone inlet and discharged via the corresponding zone outlet.

2. The scroll pump device of claim 1, wherein the fluids introduced into the inner and outer zones may be the same or different.

3. The scroll pump device of claim 2, wherein the fluids introduced into the zones have different molar flow rates.

4. The scroll pump device of claim 2, wherein the fluids introduced into the zones have different chemical compositions.

5. The scroll pump device of claim 1, wherein one zone is used for vacuum pumping and the other zone is used for compression.

6. The scroll pump device of claim 5, wherein the outer zone is used for vacuum pumping and the inner zone is used for compression.

7. The scroll pump device of claim 1, wherein the external and internal scroll members are constructed from aluminum or magnesium.

8. The scroll pump device of claim 1, wherein the external and internal scroll members each individually weigh from about 0.05 kg to about 2 kg.

9. The scroll pump device of claim 8, wherein the external and internal scroll members each individually weigh from about 0.05 kg to 0.30 kg.

10. The scroll pump device of claim 1, wherein the internal scroll member is an orbiting member, and the external scroll member is a fixed member.

11. The scroll pump device of claim 1, wherein a vacuum between from about 4 psia and about 8 psia is produced by one zone, and a compression of a feed gas from atmospheric pressure to between from about 20 psia and about 34 psia is produced by the other zone.

12. The scroll pump device of claim 11, wherein a vacuum of about 6 psia is produced by one zone, and a compression of a feed gas from atmospheric pressure to about 26 psia is produced by the other zone.

13. The scroll pump device of claim 12, wherein the vacuum zone provides vacuum pressure and flow using fewer wraps of said spiral element than necessary to compress the gas to atmospheric pressure.

14. The scroll pump device of claim 1, wherein the device weighs from about 0.25 kg to about 3 kg.

15. The scroll pump device of claim 14, wherein the device weighs from about 0.5 kg to about 1.5 kg.

16. The scroll pump device of claim 1, wherein the scroll members have an epoxy sealant applied to their surfaces to provide improved sealing between the scroll members.

17. The scroll pump device of claim 6, wherein the internal scroll member is an orbiting member, and the external scroll member is a fixed member.

18. The scroll pump device of claim 17, wherein the vacuum zone provides vacuum pressure and flow using fewer wraps of said spiral element than necessary to compress the gas to atmospheric pressure.

19. The scroll pump device of claim 18, wherein the scroll members have an epoxy sealant applied to their surfaces to provide improved sealing between the scroll members.

20. The scroll pump device of claim 19, wherein a vacuum of between about 4 psia and about 8 psia is produced by the outer zone, and a compression of a feed gas from atmospheric pressure to between about 20 psia and about 34 psia is produced by the inner zone.

21. The scroll pump device of claim 20, wherein a vacuum of about 6 psia is produced in the outer zone, and a compression of a feed gas from atmospheric pressure to about 26 psia is produced in the inner zone.

22. The scroll pump device of claim 21, wherein the external and internal scroll members each individually weigh from about 0.05 kg to about 2 kg.

23. The scroll pump device of claim 22, wherein the external and internal scroll members each individually weigh from about 0.05 kg to 0.30 kg.

24. The scroll pump device of claim 23, wherein the device weighs from about 0.25 kg to about 3 kg.

25. The scroll pump device of claim 24, wherein the device weighs from about 0.5 kg to about 1.5 kg.

26. A method of separating and concentrating an element of a fluid using the scroll pump device of claim 5, comprising the steps of:
introducing the fluid into the compression zone of the scroll pump device to provide a pressurized fluid feed stream;
introducing the pressurized fluid feed stream into a separator/concentrator, wherein the separator/concentrator is adapted to separate the components of the pressurized fluid feed stream to produce a concentrated product fluid and a waste fluid;
collecting the concentrated product fluid from the separator/concentrator; and
removing the waste fluid from the separator/concentrator by operation of the vacuum zone of the scroll pump device.

27. The method of claim 26, wherein the fluid is air.

28. The method of claim 27, wherein the separator/concentrator is a pressure vacuum swing adsorption system adapted to separate the pressurized feed air into oxygen-rich product fluid and oxygen-depleted waste fluid.

29. The method of claim 28, wherein the separator/concentrator generates oxygen at a flow rate of about 10 liters per minute or less.

30. The method of claim 29, wherein the separator/concentrator generates oxygen at a rate of from about 0.5 to about 6 liters per minute.

31. The process of claim 30, wherein the separator/concentrator generates oxygen at a rate of 0.5 to 3 liters per minute of oxygen, and wherein the oxygen is at least 85% pure.

32. The process of claim 30, wherein the separator/concentrator generates oxygen at a rate suitable for use in a portable medical oxygen generator.
